(19) United States
(12) Patent Application Publication
(10) Pub. No.: US 2001/0034775 A1
(43) Pub. Date: Oct. 25, 2001

(54) Method, computer product and network system for receiving and placement processing of advertising information

(76) Inventor: Masahiro Minowa, Nagano-ken (JP)

Correspondence Address: HOGAN & HARTSON L.L.P., 500 S. GRAND AVENUE, SUITE 1900, LOS ANGELES, CA, 90071-2611, US

(21) Appl. No.: 09/818,125

(22) Filed: Mar. 26, 2001

(30) Foreign Application Priority Data
Mar. 27, 2000 (JP) 2000-087280

(51) Int. Cl. G06F 15/16; G06F 15/173

(52) U.S. Cl. 709/218; 709/225

(57) ABSTRACT

An advertising placement processing method and system enabling the information placement application process to be accomplished over the Internet, the system being a system for placing various information, including advertisements, introductions, event announcements, help wanted ads, looking to buy notices, announcements, and requests for assistance, on receipts issued from a POS terminal, vouchers issued by a kiosk terminal, and queuing number tickets issued from queuing number issuing devices in banks, for example. Information relating to the advertising application, advertising information, and advertising fee payment information is sent from a client PC via the Internet to a server system; the server system calculates fee information according to the received advertising information, and sends it via the Internet to the client PC. After confirming completion of the payment process, the server system sends the advertising information to a central system, and the central system distributes the received advertising information to the plural POS systems connected to the central system. A store POS system that receives the advertising information prints the advertising information together with the transaction information for the purchased products on the receipt issued during the customer purchase transaction process.

### BACKGROUND OF THE INVENTION

1. Field of the invention

The present invention relates to an advertising placement system, and to a method for processing placement application receiving and placement, for printing by way of the Internet advertisements, introductions, event announcements, and other types of information (referred to below as “advertising information”) to, for example, a receipt or customer service number ticket issued by a so-called point-of-service (POS) terminal such as a cash register in a store, a check-out counter terminal in a super market, or a queuing number issuing device in a bank, securities company, or hospital, for example.

2. Description of Related Art

POS (point-of-sale) systems that can also be used to put advertising information (advertisement or ad) directly into the hands of customers are already used in convenience stores, grocery stores, and other retail businesses. One such type of POS system provides advertising by printing receipt information to receipt paper having advertisement preprinted to the front or back of the paper. Another such POS system that prints advertisements and other information entered from a data entry terminal located in the stored to receipts as added-value information is proposed by laid open European patent application EP-A-1 035 527. The former type of POS system is suited to providing fixed, constant advertising content for a relatively long period of time. The latter type of POS system makes it possible to directly provide individual local residents with advertisements and information about local events. As lifestyles change, such systems could in the near future become an extremely effective advertising medium.

While the former type of system is, as noted, suited to providing fixed, constant advertising content for a relatively long period of time, the drawback to this method is that the advertisement cannot be readily changed because of the time lag inherent with using preprinted paper. It is therefore difficult to satisfy demand for changing ad content in a timely manner.

Furthermore, in order for an advertiser to place an advertisement using the latter type of system, the advertiser must visit the store where the data input terminal is located in order to apply for placing an advertisement using the data input terminal. The application process is therefore cumbersome. In addition, the desired advertising placement information must be input during the application process, and the information that can be placed in the advertisement could be limited depending upon the capabilities of the data input terminal. It may not be possible to enter image data, for example, if the data entry terminal can only handle text. Furthermore, both money and space are needed to install the data input terminal for accepting advertising applications. The data input terminals are desirably located in as many stores as possible if the convenience of the advertiser is considered, and the associated cost and space requirements are thus a significant burden for the system provider.

### SUMMARY OF THE INVENTION

The present invention was conceived with consideration for the above problems, and an object of the present invention is to provide an advertising system that can accept advertising placement applications by way of the now widely available Internet, and can print the advertising information by way of POS terminal devices, and a method for accepting placement applications and placing advertisements. The POS terminal devices are typically located in retail chain branches (including individual stores) or stores subscribing to advertising information distribution services, and the advertiser can select the store or stores for placing the advertisement.

It should be noted that as used in this specification a “branch” includes branches of a bank, securities company, or other organization, branches of a supermarket, department store, or other type of store, and affiliated stores, such as convenience stores, interconnected by a specific contract (referred to as convenience stores below). Furthermore, a “POS terminal device” as used in this specification means a “point-of-service” terminal device which has been used in a broad sense and includes not only cash registers connected to a POS system used in a store, but other types of devices for issuing such printed matter as tickets and queuing numbers, and transaction statements issued by automated teller machines (ATMs).

To achieve the above objects, the present invention provides a network system having an advertising information management server system connectable to a client PC via the Internet, and a POS system connected to a POS terminal device having at least a display device and a printing device, the network system comprising: (a) means for storing an application page containing an advertising placement application form; (b) means for sending the application page containing the application form to the client PC in response to a request from the client PC; (c) means for receiving and storing input information containing advertising placement information provided by the client PC in accordance with the application form; (d) means for distributing specific data in the input information to the POS system specified by the client PC; and (e) control means for controlling printing the advertising placement information on the POS system receiving the distribution.

Thus comprised, an application for placing an advertisement can be made easily because an application can be made by accessing the server system over the Internet from a PC at home, for example. In addition, because the advertising placement information on the received application can be distributed to POS systems via a LAN, WAN, the Internet or the like, it can be immediately distributed to the necessary stores so that placing the advertisement can begin quickly.

Preferably, the network system further comprises (f) means for calculating an advertising placement fee based on the input information; (g) means for storing and sending the requested fee to the client PC that applied; and (h) means for confirming fee payment.

Thus comprised, the client can quickly determine the fee according to the advertising area and advertising information. In addition, the advertising information can be distributed after confirming payment of the advertising fee.

The network system further comprises a plurality of POS systems each being installed corresponding to each of chain stores having a plurality of branches or subscriber shops.

Thus comprised, the advertising placement can be handled by the identical manner to be printed.

The application page used in a network system according to the present invention preferably contains a check box enabling selection by the client PC of at least one place name or area name from among a plurality of names of places or areas where the branches or subscriber shops exist.

Thus comprised, effective placement of advertisements is possible because the applicant can select only the necessary one or more stores or shops from the multiple stores or shops having POS systems connected to the network. Furthermore, the necessary data can be distributed immediately to any area so long as it is connected to the network, and it is therefore possible to specify the advertisement region quickly and easily and advertisements can be placed in the selected places or areas.

The application page preferably contains a check box enabling selection by the client PC of one or more chain stores where an advertisement can be placed.

Thus comprised, the advertising placement area can be specified with almost pinpoint accuracy, and more economical, effective advertising is possible. Specifying an advertising area is beneficial not only for the advertiser but also for the advertising placement service because limited advertising space can be efficiently used.

The application page preferably enables specifying a target to whom the advertising placement information is to be presented. This also enables effective advertising by the party placing the advertisement, and at the same time enables the service provider to efficiently use advertising space.

The means (d) for distribution to the POS system preferably includes a central computer. A plurality of POS systems are generally managed en masse by a POS server system, i.e., the central computer. It can therefore be more efficient in distributing specific data from the POS server system to the necessary POS systems.

The POS server system or central computer is preferably connected to the advertising information management server system via the Internet. This enables a POS system to not only be connected to the internal network, but can also distribute to external POS systems connected via the Internet. Transmission to external systems via the Internet can be accomplished using an e-mail system, FTP, or other protocol.

Another aspect of the present invention is an advertising information receiving and placement processing method for a network system having a server system to which a client PC can be connected via the Internet, and a POS system connected to a POS terminal device having at least a display device and a printing device. The processing method comprises: (a) sending an application page containing an advertising placement application form in response to a request from the client PC; (b) receiving and storing input information containing advertising placement information provided by the client PC in accordance with the application form; (c) calculating an advertising fee based on the input information; (d) sending to the client PC a payment specification form containing the calculated fee information; (e) confirming fee payment; (f) registering in the POS system advertising information for which payment has been confirmed; and (g) outputting advertisement by means of the display device or printing device of the POS terminal device.

Step (e) of the method preferably includes a step for confirming credit card authorization. Such authorization can be accomplished using a CAT system or other systems.

Step (f) preferably includes a step for sending specific information in the input information to the POS system specified by the input information. It is therefore possible to limit the POS systems to which advertising information is sent, thus preventing unnecessary distribution, and reducing the computer load and traffic.

Step (f) preferably includes a step for confirming a corresponding POS system from a desired advertising area specified by the input information, and a step for sending specific information in the input information to the confirmed POS system. Correct distribution to the specified area is thus possible.

Step (f) preferably includes a step for distribution by way of a central computer connected to a plurality of POS systems.

Step (f) preferably includes a step for sending specific information in the input information to said POS system by way of the Internet.

According to another aspect of the present invention, a network system is connected to an advertising information management server system to which a client PC can connect via the Internet, and a POS terminal device having at least a printing device for printing a receipt or ticket. The network system comprises (a) a storage unit for storing an application page containing an advertising placement application form sent to the client PC; (b) an application receiving means for sending the application page containing the application form to the client PC in response to a request from the client PC; (c) a storage unit for receiving and storing input information containing advertising placement information provided by the client PC in accordance with the application form; and (d) a data distribution managing unit for distributing specific data in the input information to a POS terminal device specified by the client PC. In this network system the POS terminal device to which the specific data is distributed prints the advertising placement information simultaneously to issuing a receipt or ticket.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows a first example of a network system according to the present invention.

FIG. 2 shows an example of the basic configuration of an ADS system 1 in FIG. 1.

FIG. 3 shows the appearance of a client PC 5.

FIG. 4 is a function block diagram of client PC 5.

FIG. 5 shows an example of the configuration of POS system 3.

FIG. 6 shows a convenience store POS terminal 51 as an example of a POS terminal device 50.

FIG. 7 is a block diagram showing the basic configuration of POS terminal 51 in greater detail.

FIG. 8 shows a queuing number issuing device 65 as another example of a POS terminal device 50.

FIG. 9 is a flow chart of the advertising placement application process involving the client PC 5 and ADS system.

FIG. 10 shows an example of an application page 13.

FIG. 11 shows an example of a transaction processing page 14.

FIG. 12 is a flow chart of a process for distributing advertising information from ADS system 1 through central computer 2 to POS system 3.

FIG. 13 is a flow chart showing the flow of a process whereby accounting information is entered and printed together with placement information on a receipt in a POS system 3 using POS terminal 51 shown in FIG. 6 as POS terminal device 50.

FIG. 14 is a flow chart showing process steps replacing steps S400 and S401 on the POS terminal 51 side in FIG. 13.

FIG. 15 shows an exemplary display of an advertising information list presented on an information selection device.

FIG. 16 shows an exemplary receipt having advertising information printed below the transaction data.

FIG. 17 shows an exemplary receipt having plural blocks of advertising information printed below the transaction information with the advertising information reduced in scale for printing.

FIG. 18 shows another example in which the advertising placement information is printed above the transaction information.

FIG. 19 shows an exemplary queuing number ticket having advertising information printed below the queuing number.

FIG. 20 shows another example of an application page for entering advertisement management information.

### DESCRIPTION OF PREFERRED EMBODIMENTS

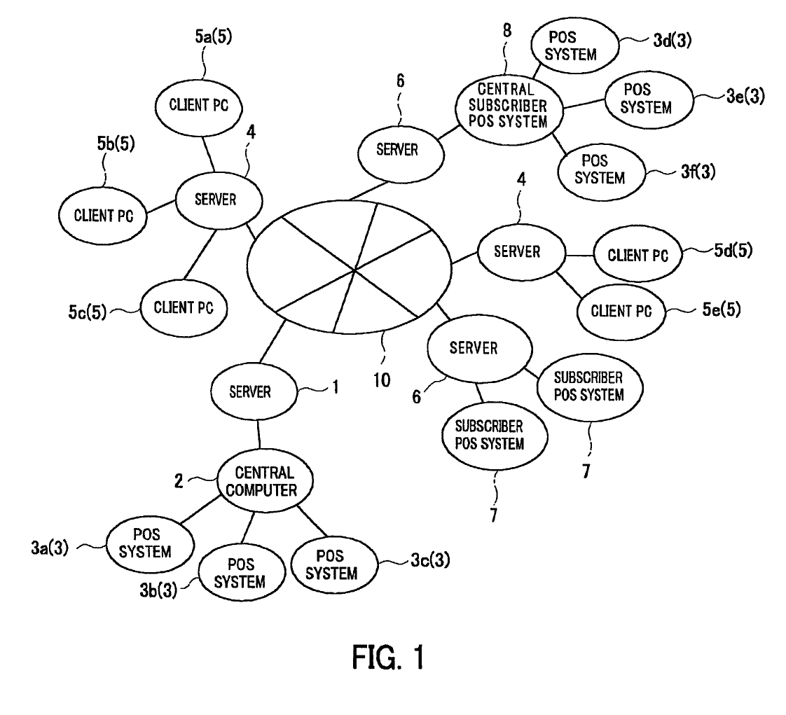

FIG. 1 shows a first embodiment of a network system according to the present invention. In this figure reference numeral 1 denotes an application/distribution server (ADS) system for managing advertisement information, including receiving application for advertising placement and distributing advertising placement information, and reference numeral 2 denotes a central computer. The central computer 2 is a system that is connected to a point-of-sale management system (referred to below as a POS system). Each POS system is located in a convenience store or the like, and includes one or more POS terminal devices and provides central management of data collected from the one or more POS terminals. It should be noted that the term POS system is often used as including the central computer 2, i.e., both the store-side systems and the central computer 2 as a central system. In this specification, however, the term “POS system” is used to mean only a store-side system separate from the central system. It should be further noted that in addition to POS systems such as those used in convenience stores, department stores, supermarkets, and shopping malls, the term as used in this text also includes various types of systems for issuing particular printed matter to customers, including queuing number issuing systems as they are used in banks and securities companies, for example; nowadays such systems are also called POS system with POS then standing for “Point-Of-Service”.

Although five POS systems 3a to 3e located in stores are shown, unless a distinction between these systems is necessary, reference numeral 3 will be used to refer to all or an arbitrary one of these systems. Each POS system 3 is a system for managing POS terminal devices (further described below), which are installed in the respective store or shop, for issuing receipts, for example, on which advertising information (advertisements) may be placed. Reference numerals 4 and 6 denote servers connected to the Internet 10. Reference numerals 5a to 5e are client computers (referred to as client PCs below), e.g., personal computers (PCs) that may apply for having an advertisement placed. Although five client PCs 5a to 5e are shown, unless a distinction between these PCs is necessary, reference numeral 5 will be used to refer to all or an arbitrary one of them.

A client PC 5 accesses ADS system 1 via server 4 through the Internet 10. The client PC 5 can be a personally owned personal computer, or a computer connected to the LAN or WAN of a particular organization, such as a company. The server 4 to which client PC 5 connects can belong to a separate ISP, or be owned by the user of the client PC 5 himself. Server 4 will be referred to as ISP server hereinafter.

The ADS system 1 transmits an application form in response to a request from client PC 5. Based on the obtained application form, client PC 5 returns specific application information including customer information and advertisement management information, and advertising placement information (which correspond to the content of the advertisement). The ADS system 1 stores the received information and sends a fee payment (billing) form to the client PC 5. Exemplary forms are described in further detail later.

After confirming payment, ADS system 1 distributes, by way of central computer 2, the advertising placement information, advertisement management information and customer information (collectively advertisement information) to one or more of the POS systems 3 specified by client PC 5. It should be noted that while not shown in the figure direct distribution to POS system(s) 3 bypassing central computer 2 is also possible by using a client-server system or other such in-house network system. The advertisement management information includes restriction items such as the advertisement distribution area, advertising targets (to whom the advertisement should be presented), the advertising period, an advertising time period of the day or total number of copies of the advertisement that may be printed (referred to as “copy number” hereinafter).

The POS system 3 that received the advertisement information from ADS system 1 runs a process for printing the advertisement in addition to the information normally printed (such as the sales price of purchased items) on a receipt issued by a POS terminal device. The advertisement is printed according to the advertising placement information and according to the advertisement management information.

ADS system 1 can distribute the advertisement information including the received advertising placement information via the Internet 10 to other subscriber POS systems 7 through the server 6 which is, for example, of a type of an application service provider (ASP) server to which multiple individual shops are subscribing. A subscriber shop can be any type of commercial enterprise, but particularly includes, for example, clinics, hospitals, pharmacies, and small- and medium-size stores. In a hospital or pharmacy, for example, receipts, queuing number tickets, and other printed matter is issued by registers for calculating treatment fees and hospitalization charges, queuing number issuing devices for issuing queuing number tickets in the waiting order, and registers in pharmacies providing drugs according to a doctor's prescription. POS systems such as noted above, POS terminal devices used in subscriber POS systems, for example, cash registers, check counters and other devices such as queuing number issuing devices are collectively referred to in this invention as “POS terminal devices”.

Subscriber POS systems can be large-scale systems. In this case, advertisement information can be sent from the ADS system 1 via the Internet 10 to the subscriber store's central system 8, and distributed from there to individual POS systems. It is therefore possible to place an advertisement by means of a great number of POS terminal devices through the networks of plural corporations or organizations.

ADS System

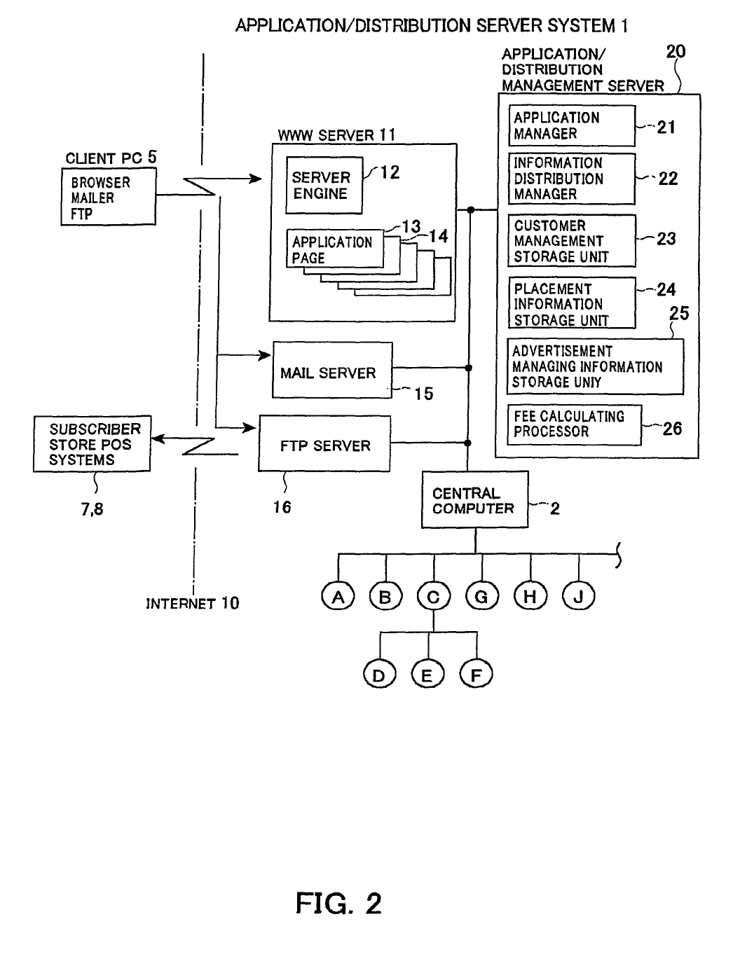

FIG. 2 shows the basic configuration of an ADS system 1. WWW server 11 stores a home page (not shown in the figure) and other Web pages connected to a data base (not shown in the figure) containing the information about the stores, shops, chain stores and other service businesses, and sends the home page or other Web page to a client PC 5 in response to a request from that client PC 5. The home page can be captured and viewed using a browser or other application on the client PC 5. For example, assume that a client PC 5 wants to view the home page and apply to place an advertisement. The home page may be set up, for example, so that an application page transmission request is sent to the WWW server 11 when a particular place on the home page is clicked. When an application page request from client PC 5 is received, server engine 12 of the WWW server 11 sends the application page 13 to the client PC 5.

The application page presents an application form into which client PC 5 (its user) enters required application information, including customer information (his customer details), advertisement management information, and advertising placement information, and sends the entered information to the ADS system 1. When the data sent from client PC 5 is received, WWW server 11 of ADS system 1 passes the data to an application/distribution management (ADM) server 20. The ADM server 20 runs a particular process as necessary. The WWW server 11 and the ADM server 20 can be linked in this case by way of a common gateway interface (CGI), for example.

Advertising placement information specifies the content of the advertisement, and may contain text data and/or image data, such as pictures, photographs, etc. Any method can be used for receiving such image data from the client PC 5. For example, image data can be sent as a file attachment to an e-mail message from client PC 5 to be received by mail server 15. It is also possible to embed an ID and password for an FTP server 16 in the application page 13 so that the image file is sent by file transfer protocol (FTP) automatically to an FTP server 16 by operating the application page 13.

Application manager 21 of the ADM server 20 applies a specific process to data input by processing the application page 13. Customer information is stored in a customer management information storage unit 23, advertisement management information is stored in an advertisement managing information storage unit 25, and advertising placement information is stored in a placement information storage unit 24. These storage units 23 to 25 are preferably structured as a database, but the individual files can be stored instead. Properly registered information stored in the above storage units is managed by information distribution manager 22, which runs an information distribution process.

The application manager 21 calculates an advertising fee from the type, amount, advertising period, copy number, and the advertisement distribution area, and sends a payment page to the client PC 5 via WWW server 11. The application manager 21 confirms the application when the specified fee is paid, and finalizes the application transaction so that the information stored in the storage units 23 to 25 becomes effective. When the specified fee is paid, information distribution manager 22 sends the data needed for advertising, including the advertising placement information, advertisement distribution area, and advertising period, to the central computer 2 based on the management information. Certain management information, such as the maximum number of copies of an ad, need not be sent to the central computer 2 because the total number of copies printed is to be coordinated by the information distribution manager 22. The central computer 2 then sends this data to the POS systems 3 in the advertisement distribution area specified by the client PC 5. In this case it is possible to specify distribution to only stores A, B, D, and F of POS systems A to J. It should be noted that an example of a hierarchical connection to the central computer 2 is shown in FIG. 2, but a client-server system architecture is also possible. The network can also be either a local area network (LAN) or wide-area network (WAN).

If there are subscriber POS systems 7, 8 of an external advertising placement service not connected by the ADS system 1 and internal network, the data needed for advertising is transmitted via Internet 10. This transmission can be accomplished by the subscriber POS systems 7, 8 periodically requesting file transmission from FTP server 16, or by ADS system 1 sending to an FTP server (not shown in the figure) of the subscriber POS systems 7, 8. If these subscriber POS systems 7, 8 are connected by a communications line other than the Internet, transmission by such communications line is also possible. In addition to these methods, transmission using a mail system is further possible.

In addition to the above noted data distribution process, information distribution manager 22 also runs a process for terminating an advertisement and calculating advertisement fees or fee adjustment based on the managing information. More specifically, if the advertising period, for example, is specified in the advertisement management information, the information distribution manager 22 stops distribution when the advertising period is over. If a copy number is specified in the advertisement management information, the information distribution manager 22 regularly collects from the central computer 2 or subscriber POS system the number of advertisements actually printed, calculates the total print count, and terminates distribution when the printed copy number reaches the specified copy number.

If distribution is limited to only POS systems connected to the central computer 2, distribution management such as described above can be handled by the central computer 2.

Client PC

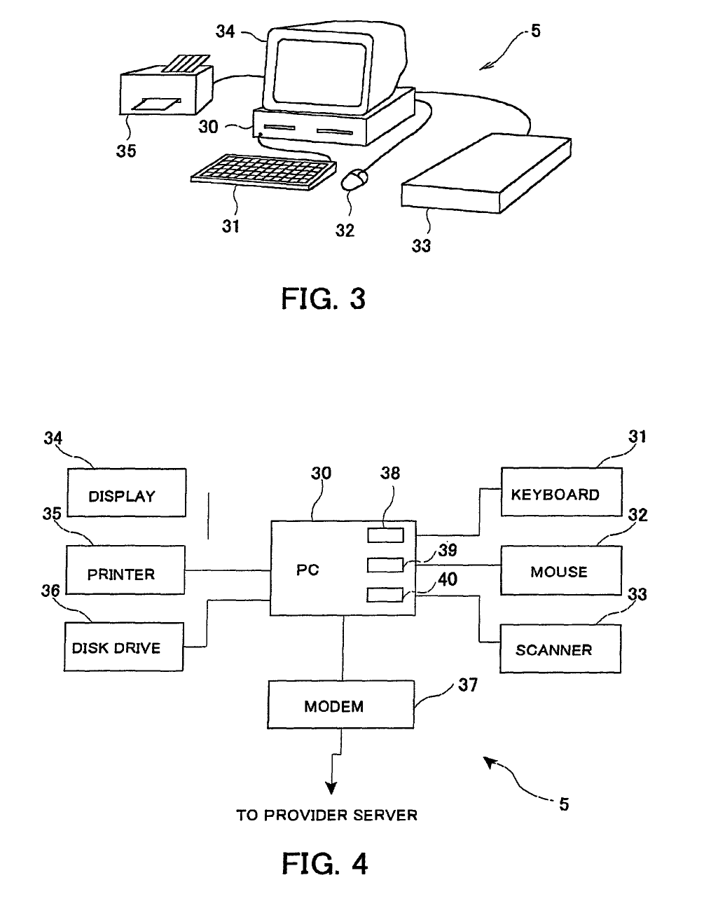

An example of a client PC 5 is shown in FIG. 3 and FIG. 4. Client PC 5 can be a general purpose PC used in the home, or a PC connected to an in-house corporate LAN. A client PC 5 using a general purpose PC unit 30 used in the home is described here.

In a basic configuration, PC unit 30 has a keyboard 31, mouse 32, display 34, disk drive 36, and modem 37 connected thereto; a scanner 33 for capturing an image of a picture, a printer 35 for printing image data and data processed by the PC unit 30, and other devices can also be connected.

A CPU, memory, and various registers (not shown in the figure) are provided inside PC unit 30 with the basic operation thereof controlled by a general purpose operating system (OS). Windows (registered trademark) and Macintosh (registered trademark) are typical examples of a general purpose OS. A browser 38 is generally loaded on such a client PC 5, enabling an HTML screen to be obtained from WWW server 11 via Internet 10 and presented on display 34. E-mail software (a mailer) 39 and FTP (file transfer protocol) software 40 are also standard programs provided as programs for connecting to the Internet.

A browser 38, mailer 39, and FTP application 40 are standard software provided with a general purpose PC system. Sending data to and receiving data from ADS system 1 via the Internet 10 is possible using these applications in client PC 5.

Connecting to the Internet 10 from a home client PC 5 generally requires a contract with an ISP enabling the client to connect to the ISP server via telephone lines. Because digital/analog conversion, etc., is necessary to connect to a telephone line from a client PC 5, connection to the telephone network is made using a modem 37. A DSU (digital line termination unit) and TA (terminal adapter) (not shown in the figure) are required to use ISDN (integrated service digital network).

A client PC 5 having the above-noted functions as standard software can access ADS system 1 via the ISP server 4, and access a home page or advertisement application page 13 from WWW server 11. The captured page can be viewed by the browser 38 on display 34, and data can be entered into the displayed form using keyboard 31 and a pointing device such as a mouse 32.

If a particular place on the application page 13 is clicked at when the required data entry is completed, or if accessing other necessary information is desired, particular data is sent to the ADS system 1 according to data linked to the place on the page 13 that was clicked at. The ADS system 1 receiving this data then responds by running a corresponding process, such as transmitting a another Web page specified the data received from the client PC 5.

With client PC 5, an image of a picture or photograph for placing in the advertisement can be captured using scanner 33. Corresponding image data may be stored (“store” as used in this specification means storage to memory as well as recording on a disk, such as disk drive 36, or a CD). The stored image data can also be processed to be suitable for the advertisement and stored as a file.

POS system and POS terminal device

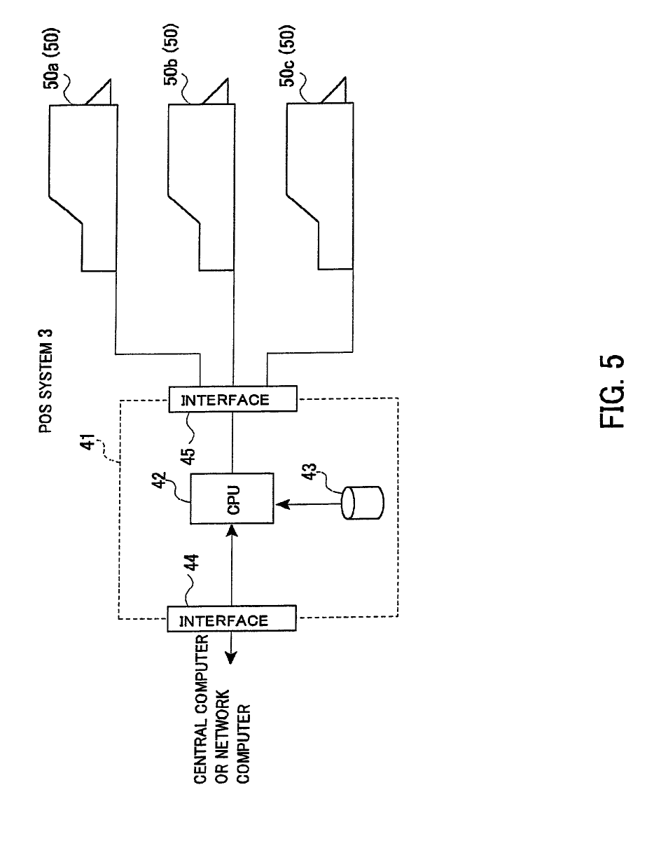

An exemplary configuration of a POS system 3 is shown in FIG. 5. This POS system 3 comprises a store server 41 and a plurality of POS terminal devices 50 (three terminal devices 50a to 50c are shown) connected to the store server 41. It should be noted that a store server 41 is not necessarily provided in each store, instead one can be provided for plural stores.

The various parts of store server 41 are controlled by CPU 42. Store server 41 communicates with central computer 2 through interface 44 and with POS terminal devices 50 through interface 45 on the side of POS terminal device. Store server 41 receives the advertising placement information and some or all of the advertisement management information from central computer 2, and stores this information on a hard disk or other storage device 43.

A product database can be stored in storage device 43. In this case, when CPU 42 receives a product identification number from a POS terminal device 50, it sends the price of that product to the POS terminal device 50.

The store server 41 can send product sales information to the central computer 2, and can obtain stock plans, updated product prices, as well as information related to advertisement that is to be placed using conventional methods, from central computer 2. Direct communication with ADS system 1 is also possible by connecting to a computer communication network using telephone lines, for example, through a network interface not shown in the figure. The store server 41 functions as a storage unit for various data, and in conjunction with POS terminal devices 50 functions as an advertisement printing control means.

Note that while the configuration of a POS system 3 is shown in this example, subscriber POS systems 7, 8 connect to the Internet 10 through an ISP or other server 6 rather than connecting through interface 44 to central computer 2 (see FIG. 1).

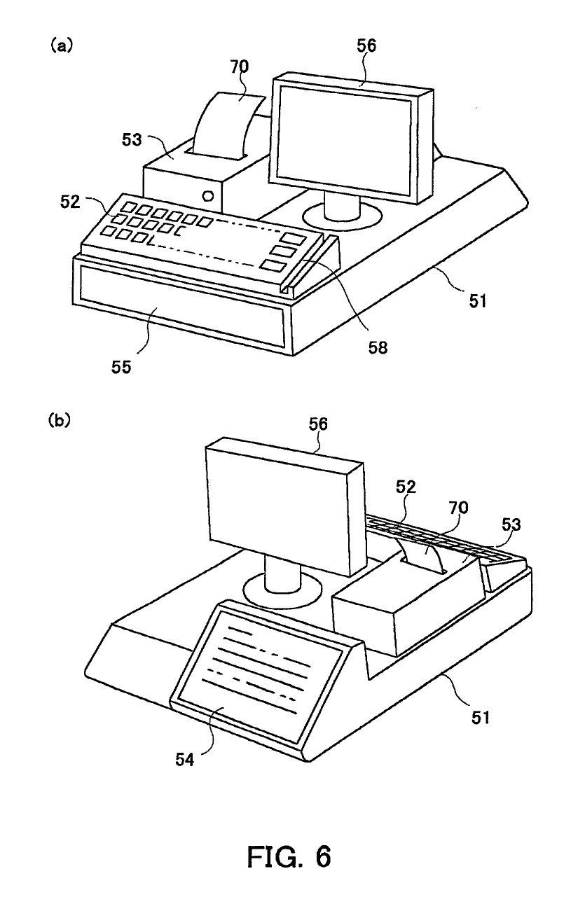

A convenience store POS terminal 51 is shown as an example of a POS terminal device 50 according to the present invention in FIG. 6. POS terminal 51 has an operator keyboard 52, printer 53, operator display 56, cash drawer 55, card reader 70 and information selection device 54 having a display module (not shown if the figure) for a customer. When there is a purchase request from a customer in a convenience store, the customer's age, sex, and other customer information is first entered. This data is collected and analyzed by central computer 2 as marketing strategy information, such as for sales analysis. After entering the customer information, the purchased products are registered, and when all product registrations are completed, a receipt 70 having the purchased items, total price, and sales tax printed thereon is issued from printer 53 and passed to the customer.

It should be noted that a product registration as this term is used herein includes processes such as reading a bar code, etc., on the product to obtain a product ID, get the product price from the storage device 43 of store server 41, store the name, price, and quantity of the purchased product in storage device 43 or POS terminal 51, and subtract the purchased quantity from the inventory data.

A POS terminal device 50 used in the present invention can further print advertisements on the receipt 70, making it possible to advertise by handing this receipt with one or more advertisements printed thereon to the customer. In the case where the printer has two print heads that can print on both sides of the receipt, respectively, the advertisement can be printed on the rear side of the receipt.

POS terminal 51 in FIG. 6 differs from a conventional POS terminal in that it has an information selection device 54. This is not essential to the present invention, but is a device enabling the customer to select one or more advertisements from a menu of advertisements. The information selection device 54 has a display part and an input part so that the desired advertisement(s) can be selected using the input part from a list displayed on the display part. The input part can be a touch panel on the screen of the display part, or can be a customer keyboard (not shown in the figure). It is also possible to have the customer tell the operator the item number(s) of the desired advertisement(s) so that the selection is entered at the operator keyboard 52. A specific process is described further below.

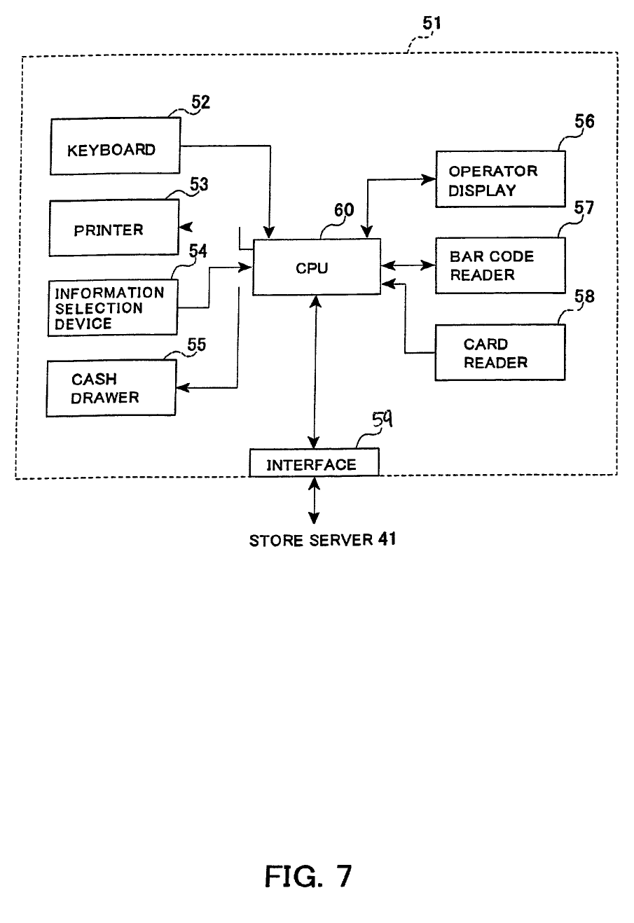

FIG. 7 is a block diagram showing a more detailed basic configuration of POS terminal 51. POS terminal 51 has operator keyboard 52, printer 53, information selection device 54, cash drawer 55, operator display 56, bar code reader 57 and card reader 58 connected to CPU 60, which controls each of these devices. CPU 60 communicates with store server 41 through interface 59.

Printer 53 is typically a receipt printer, but if the printer is capable of printing both on the front and back sides of a receipt paper as described above, the advertisement(s) can be printed on the back side of receipt. In the case where printer 53 is a color printer, advertisements can be printed in color to achieve an even greater advertising effect.

It should be noted that while a convenience store POS terminal is used as an example of POS terminal device 50 in FIG. 6 and FIG. 7, an accounting register in a hospital or pharmacy can be used as POS terminal device 50 as long as the device can register a sales transaction and issue receipt 70.

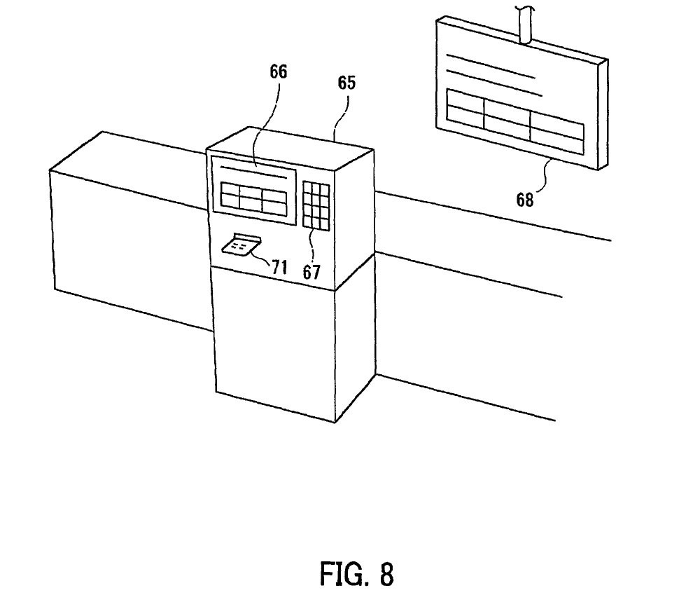

As another example of POS terminal device 50, FIG. 8 shows a queuing number issuing device 65 such as used in a bank, securities company, or hospital. A queuing number ticket having a customer number is commonly issued at such places. It is often necessary to wait a relatively long time until one's number is called for service, particularly in a bank or hospital. If information about local events can be provided while customers are kept waiting, there is a strong possibility that the information will be read with interest. Placing advertisements on such queuing number tickets is therefore an extremely effective means of advertising.

This queuing number issuing device 65 can be configured to automatically print only predetermined advertising information. However, as shown in FIG. 8, it is also possible to provide the queuing number issuing device 65 with a display part 66 and keyboard 67 so that the customer can select the advertisement(s) to be printed. A touch screen could be provided on display part 66 so that selections are made directly from the display part and the keyboard 67 can be omitted. The customer selects the desired advertisement(s) from those displayed on display part 66. Customers waiting in line have available time with nothing to do, and it is therefore preferable to allow plural selections.

A large-scale display 68 is shown in FIG. 8. People waiting for their turn in a waiting room can thus be informed that information is available. By providing such a display 68 in the waiting room, someone waiting who is interested in the information can use the queuing number issuing device 65 or other printing device (not shown in the figure) to obtain the desired information.

Procedure for applying for placement of an advertisement

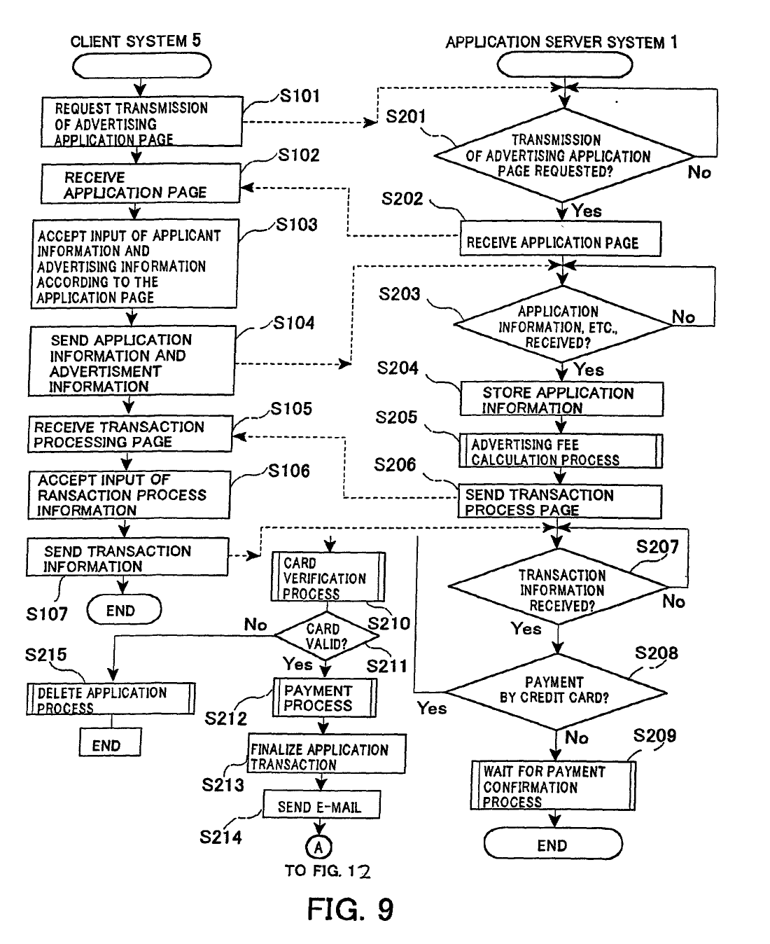

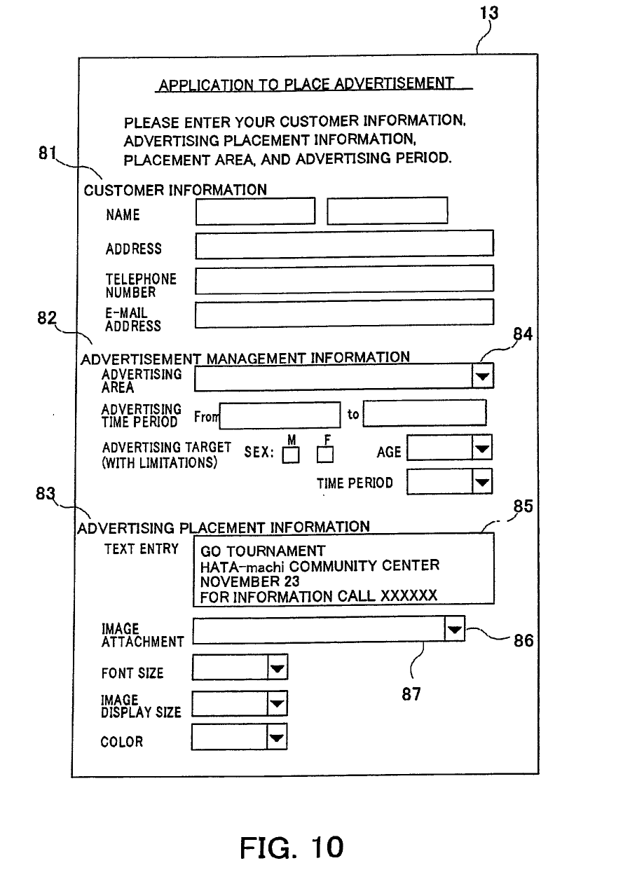

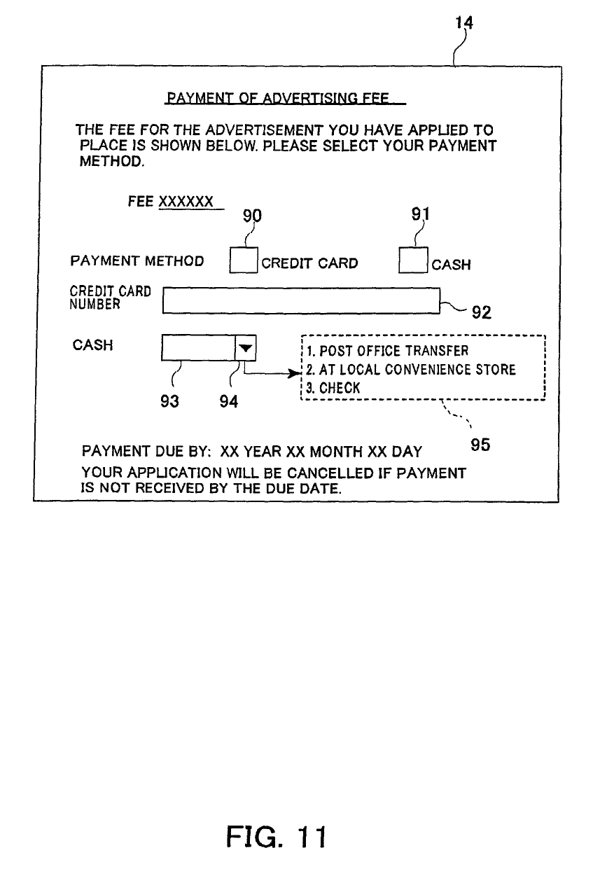

A procedure for applying to place an advertisement from client PC 5 is described using FIG. 9, FIG. 10, and FIG. 11.

Advertisement application process

(1) Application page sending and receiving

When a client PC 5 accesses the home page of ADS system 1 and selects on that home page to place an advertisement, the client PC 5 browser 38 requests the ADS system 1 to send the advertisement application page (S101). When the WWW server 11 of ADS system 1 receives this advertisement application page transmission request (S201 returns yes), it sends application page 13 to client PC 5 (S202). To simplify the following description it is assumed below that application page 13 is on the WWW server 11 and the application page is sent to the client PC 5 by WWW server 11 alone. It will be obvious that in reality the input data from client PC 5 must be received by ADS system 1. To accomplish these processes, interaction by programs on the WWW server 11 and other servers 15, 16, 20 is enabled by a common gateway interface (CGI), and application page 13 is sent to client PC 5.

When client PC 5 receives the application page 13 from ADS system 1 (S102), its browser 38 displays the application page 13 on display 34. FIG. 10 is an example of a display screen.

(2) Input to the application page and sending input data

The customer making the application enters specific information on the form he sees when the application page 13 is displayed (S103). Note that this application page 13 is an example, and other information can be requested or some of the entry items can be omitted.

First, the customer making the application enters customer information 81 such as his name, address, telephone number, and e-mail address according to the form of the application page 13 displayed on the screen. The e-mail address is used for various contacts from the advertising placement service provider. In a typical example the e-mail address is used to confirm the application and to send a bill and a receipt for fees.

Next, advertisement management information 82 is entered. This advertisement management information 82 includes advertisement restriction information for restricting the placement of the advertisement. The information 82 includes, for example, information specifying the advertisement distribution area or place (advertising area), information specifying the advertising period (advertising time period), and other such information, as well as information specifying the advertising target. The advertisement distribution area can be designated by indicating individual store names or area names. For example, specific states, prefectures, counties, districts, cities, towns, villages, or streets could be identified for selection. An entry section of a selection box containing a list of the selectable store names or regions that can be selected preferably appears when check box 84 is pointed to using a pointing device for specifying a store name or specify a region. Furthermore, if particular stores are specified for ad placement, it is also possible to designate, instead of the advertising period, the total number of receipts having the advertisement printed thereon.

The term “advertising target” (or simply “target”) refers to the type of customer whose receipts should carry a particular advertisement. Advertising becomes much more efficient when the people to receive an advertisement are selected according to the type of advertisement. This is beneficial for both the advertiser and the advertising placement service provider. The advantage for the advertiser is that the advertising hit ratio is increased by providing advertisements to selected targets. On the other hand, identifying particular targets offers the advertising service provider the advantage of being able to effectively use the space available for placing advertisements. In other words, advertising media according to the present invention can only use the extremely limited space on a receipt or queuing number ticket, and effectively utilizing this available space is extremely important. If the target customers to whom an advertisement is provided can be selected, there remains space on the receipts of other customers for other advertisements.

However, there are cases in which identifying the specified advertising target can be accomplished using POS systems 3 but also cases in which this is not possible. That is, such identification is possible only in stores in which an operator can observe the customers and enter the customer age range and/or sex at the POS terminal device 50. The party applying for advertising placement must be made aware of such restrictions when the application is made. This is why the advertising target line in FIG. 10 has the qualifier “with restrictions”. The form can also be designed so that clicking this displays a list of limited items, area restrictions, or stores with restrictions.

The advertising placement information 83 is entered after the above input is completed. This includes the advertising information that could be a text entry, for example. The example in text entry box 85 shows text for advertising event information about a go tournament. The advertising placement information can be entered in the format desired for the actual printout, or the actual format could be specified according to particular rules. The advertising information could also include image information. In this case the image entry box 87 is used for input. Attaching an image is preferably accomplished by displaying a file directory when check box 86 in the image input part is pointed to so that a previously generated file can be easily marked for attachment.

Various methods can be used for sending an attached image file to ADS system 1; a method using FTP and a method using e-mail are shown in this example. In the case of FTP transfers, the image entry box 87 is linked to the ID and password of FTP server 16 of ADS system 1 so that the file attached by image entry box 87 is sent to the FTP server 16. In the case of e-mail the image entry box 87 is linked to the mail address of the ADS system 1, and the file attached by image entry box 87 is sent as a file attachment to an e-mail message. Alternatively, the FTP server's ID and password are disclosed on the application page 13 and an applicant ID is assigned, and the applicant separately transfers the file using an FTP application in a process separate from that processing the application page 13. It is also possible to disclose the e-mail address of the ADS system 1 so that files can be sent attached to e-mail messages in a separate process.

Next, the font size of the text entered as the advertising placement information is specified. This is also preferably accomplished by displaying a selection box. It is also possible to enable specifying the display size of an image. In this case, too, a specific size can be selected from a selection box. Finally, it is also possible to enable specifying the color of the text font and the color of the image. For example, monochrome, color printing, or a particular color could be selected from a selection box. When the above input operations are completed, the input data is sent to ADS system 1 as the application information and advertisement information (S104).

(3) Receiving application information and advertisement information, and fee calculation process)

When the ADS system 1 receives the application information (the information contained in the application) from client PC 5 (S203 returns yes), the application information is stored appropriately by information distribution manager 22 in customer management storage unit 23, placement information storage unit 24, and advertisement managing information storage unit 25, respectively, as described above (S204). The advertising fee payment process has not been completed at this time, and data is therefore stored temporarily.

Next, a fee calculation process is run to calculate the advertising fee (S205). The fee calculation process is executed by fee calculating processor 26 based on conditions such as the advertisement management information stored in advertisement managing information storage unit 25, including the advertising period, advertisement distribution area, and the advertising target, and whether the advertising information stored in placement information storage unit 24 is an image, text, or requires color. When the fee calculation process ends, the WWW server 11 sends transaction processing page 14 containing the advertising fee to client PC 5 (S206).

When client PC 5 receives transaction processing page 14 (S105), the method of paying the advertising fee is specified and other specific input is entered according to the input instruction form (S106). An exemplary transaction processing page 14 is shown in FIG. 11. First, either credit card or cash is selected as the payment method using check box 90 or 91. If payment by credit card is selected, the credit card number is entered to entry box 92. The credit card number is preferably encrypted for transmission. Encryption in this case can be accomplished by, for example, a public key encryption method.

If payment by cash is selected, the place where payment will be submitted is selected using entry box 93. In this case it is preferable to open selection box 95 by pointing to check box 94 as shown in FIG. 11 so that one of plural payment methods can be selected, including payment by postal account transfer, payment at a local convenience store or bank, or payment by check. After the transaction processing information is entered, client PC 5 sends the transaction processing information to ADS system 1 (S107).

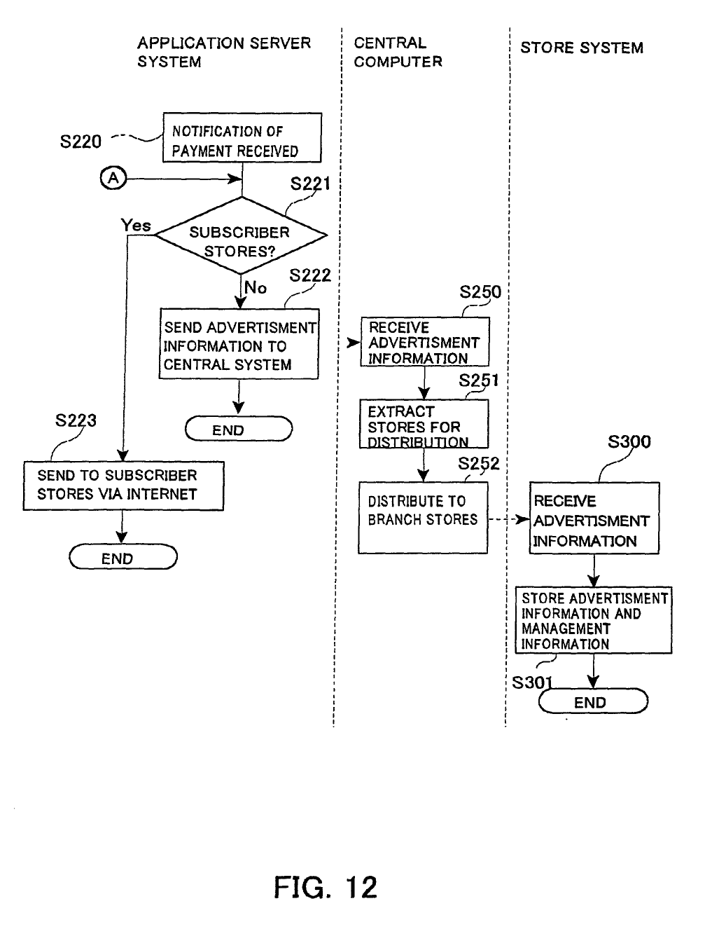

When the ADS system 1 receives the transaction processing information (S207 returns yes), application manager 21 of application/distribution management server 20 confirms payment by credit card or cash (S208). If by credit card, the validity of the credit card is confirmed using the CAT system or the like (S210). If the credit card is authorized (S211 returns yes), a payment process is run (S212) to formally register the advertising application. This authenticates the advertising application and confirms storage to the storage unit 23 to 25 of application/distribution management server 20 (S213). A credit card transaction voucher and receipt are then sent from mail server 15 (S214), and the process branches to A in FIG. 12 and a process for sending the advertising information to central computer 2 or subscriber POS systems 7, 8 is performed.

If the credit card validation process (S210) determines that the credit card is not valid (S211 returns no), the application is deleted (S215). This application deleting process deletes information stored in the storage unit 23 to 25 of application/distribution management server 20, and notifies the applicant by e-mail that the application was cancelled.

If the credit card is not valid it is also possible to inform the client PC 5 that the credit card was not valid so that another payment method can be selected without deleting the application.

If payment by a method other than a credit card is selected (S208 returns no), a payment process and a process to wait for confirmation of payment is performed (S209). More specifically, an invoice is sent by e-mail. It is also possible to enable downloading by FTP an invoice for payment sent to the applicant.

The advertising applicant then makes payment to the closest branch (convenience store or the like) of the selected store based on the invoice. When payment at the closest branch is completed, a notice of completion of payment is sent from the POS system 3 to the application/distribution management server 20 through central computer 2 or a corporate network not shown in the figures. When the payment is by postal transfer or check, the application/distribution management server 20 is similarly notified through central computer 2 or from another system through an in-house network (not shown in the figure). The application/distribution management server 20 registers payment for the application, and the application process stops until there is a notification of completion of payment.

(4) Distributing advertising placement information to POS systems

A process for distributing advertising information to POS system 3 through central computer 2 from application/distribution management server 20 of ADS system 1 is described with reference to FIG. 12.

When payment of fees, etc., is completed, a payment completion notice is sent from a POS system such as POS system 3 to application/distribution server system 1. When the payment completion notice is received (S220), or when payment is by credit card (branch A in FIG. 9), application/distribution management server 20 determines whether the advertising application contains subscriber POS systems 7, 8 in the specified advertising area (S221). If subscriber POS systems 7, 8 are not included, application/distribution server management server 20 sends the advertising information to central computer 2 (S222). When central computer 2 receives the advertising information (S250), it confirms the advertising area selection information in the advertising information and extracts the POS system 3 to which distribution is indicated (S251), and then distributes the advertising information to the corresponding POS system 3 (S252). The store server 41 of the POS system 3 that receives the advertising information (S300) stores the advertising information and advertising management information in storage device 43 (S301).

Preparing the POS system 3 to print advertising placement information on receipts or other media by means of POS terminal device 50 is thus completed. The advertising period and advertising times, printed advertisement count, and other restrictions are also managed by the application management server 20 according to the advertising management information. The advertising period can be managed by application/distribution management server 20, or by both store server 41 and application/distribution management server 20. In other words, the advertising period can be easily managed by either server because each has an internal calendar.

The total print count, however, must be managed by the application management server 20 because the total print count cannot be determined by the store servers or central system. When the total print count reaches the number that the advertiser designated, the application management server 20 instructs each of the store server or central system to stop the advertising operation.

If subscriber POS system 7 is included in the advertising area, transmission to the subscriber POS system 7 is through Internet 10 and server 4 (S223). Transmission can be accomplished by FTP or other file transmission protocol. If the subscriber POS system 8 has a central computer (see FIG. 1), the same process as for distribution from central computer 2 to POS system 3 is accomplished.

Accounting process and advertising placement information printing process

(1) Fixed selection input display

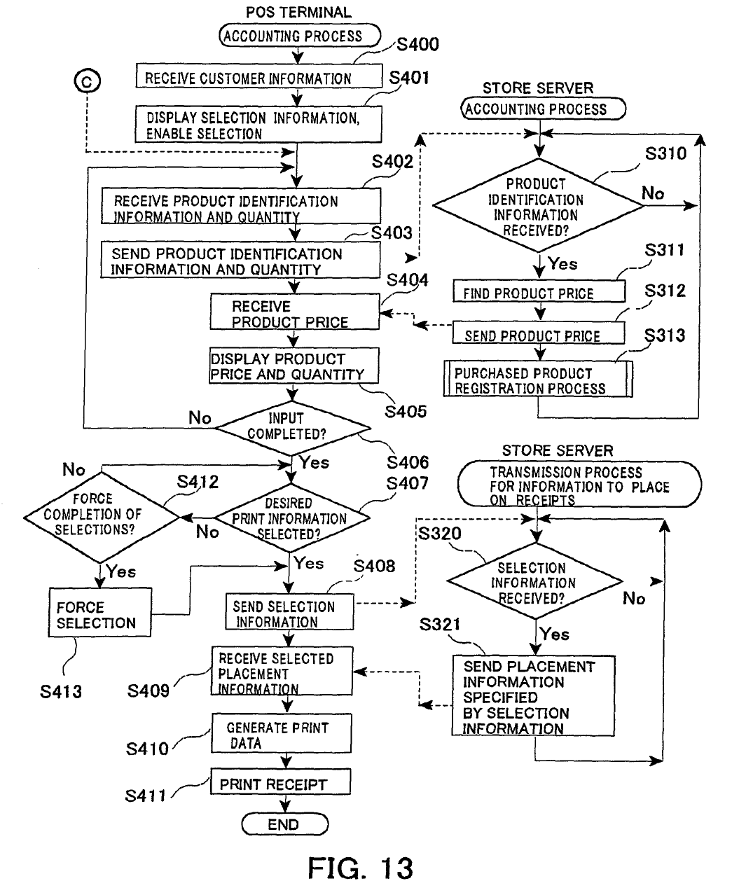

Printing advertising placement information is described with reference to FIG. 13, which is a flow chart of a process of the POS system 3 using POS terminal 51 shown in FIG. 6 as POS terminal device 50 from input of the accounting information to printing this transaction information and placement information on a receipt.

When a customer requests to pay for purchased products (accounting process) at POS terminal 51, the operator (clerk) first enters the customer's sex, age range, and other customer information from printer 53, and the CPU 60 of POS terminal 51 receives the input (S400). Next, CPU 60 displays a specific list of advertising information on information selection device 54 to enable selection entry (S401).

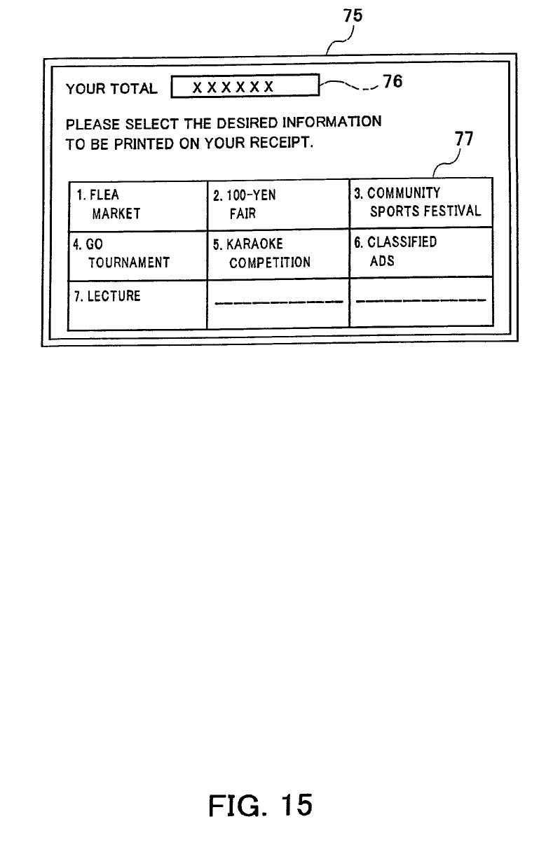

An exemplary display of an advertising information list displayed on information selection device 54 is shown in FIG. 15. A transaction amount is displayed in transaction amount display box 76 on the top line of the display screen 75 of information selection device 54. This transaction amount is the transaction total accumulated each time a purchase transaction is registered. Reference numeral 77 in the figure is an advertising information list. Selections 1 to 7 are shown in this example. The customer can select one or a plurality of the desired items. Various selection entry means could be used. In this exemplary embodiment, the display screen is a touch screen so that when list entries are presented in a matrix in this example the customer can simply touch the desired item to make a selection.

Referring back to the process flow in FIG. 13, after step S401, CPU 60 accepts input of the product identification information and product quantity information by means of bar code reader 57 and operator keyboard 52 (S402), and sends this identification information through interface 59 to store server 41 (S403).

When the server 41 receives the product identification information via interface 45 (S310), it finds the product price in the product database stored to storage device 43 (S311), and sends this price information via interface 45 to the POS terminal 51 (S312). A product registration process for the purchased product is then accomplished (S313), and the next product transaction process is awaited (S310).

POS terminal 51 receives the product price information through interface 59 (S404), and displays the price information on operator display 56 and information selection device 54 or a customer display unit (not shown in the figure) (S405).

In addition, it is then determined whether entering product identification information has been completed (S406). Entering the product identification information has been completed if, for example, the operator presses a total key on the keyboard 52.

If data entry is not complete (step S406 returns no), the procedure loops back to step S402. If data entry is complete (step S406 returns yes), CPU 60 confirms whether the customer has selected information from information selection device 54 (S407). If a selection has been made, the selected input information is sent through interface 59 to store server 41 (S408).

When the store server 41 receives the selection input information through interface 45 (S320 returns yes), the specified placement information is sent to POS terminal 51 through interface 45 (S321). CPU 60 of POS terminal 51 then receives the advertising placement information through interface 59 (S409).

The POS terminal 51 then combines the advertising placement information received in step S409 and the transaction information generated in steps S402 to S405 to generate the print data (S410), and prints a receipt by means of printer 53 (S411). Various methods of combining the information are possible, including setting aside an advertising information printing area on the receipt and printing the advertising information placed in this area, or first printing the advertising information and then printing the transaction information.

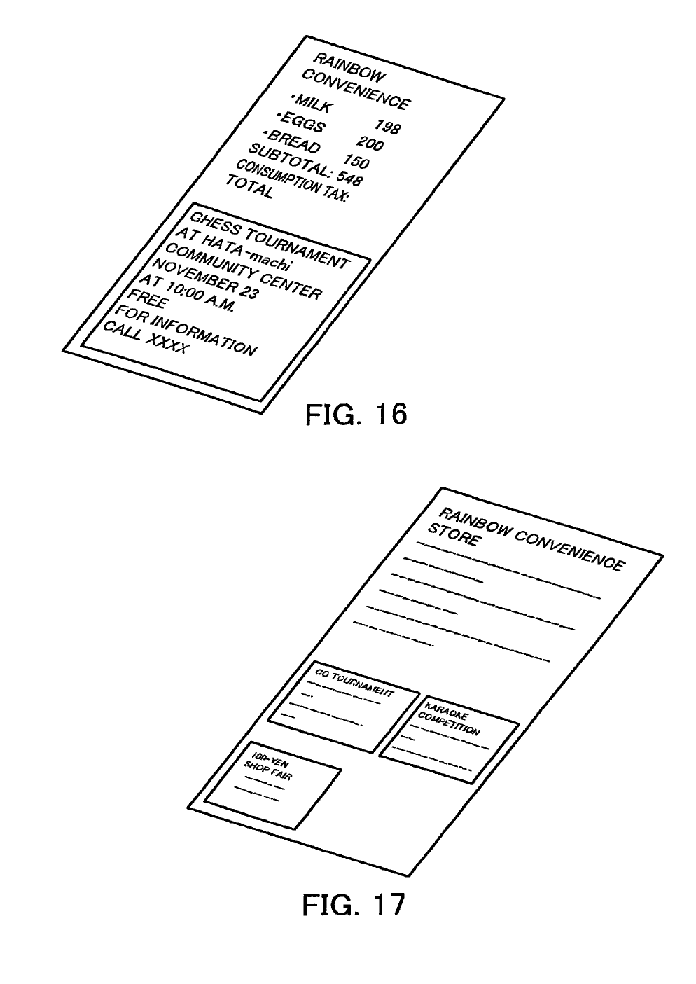

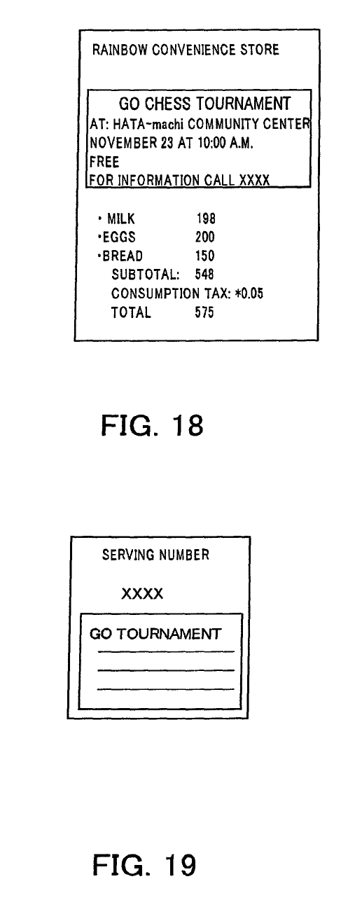

Examples of printed receipts and queuing number tickets are shown in FIG. 16 to FIG. 19. FIG. 16 shows an exemplary receipt having advertising placement information printed below the transaction data. FIG. 17 shows a receipt having the advertising information printed below the transaction information, but in this case plural blocks of advertising information are printed in reduced sizes. It is also possible to enable plural selections with each selection printed in reduced sizes. FIG. 18 shows an example in which the advertising information is printed at the top of the receipt, and FIG. 19 shows an example in which the advertising information is printed on a queuing number ticket.

(2) No customer selection

In FIG. 13 the information desired by a customer is selected using information selection device 54, but it is also possible to automatically print particular information without having the customer select the advertising placement information. A configuration such as this does not need to wait for a customer selection, and thus has the advantage of faster processing. This is particularly effective in a queuing number issuing system.

It is also possible with POS terminal 51 for store server 41 to select and print the best advertising placement information according to the customer's sex, age range, or occupation or other entered customer information. For example, the CPU 42 of store server 41 could compare the customer information with advertising target information stored to storage device 43 to select the information for which the advertising target information and customer information match, and thus print the most suitable information.

If there are plural satisfied conditions, it is also possible to select any one appropriate condition randomly or according to the frequency of use or other criteria.

(3) Changing the selection list to match customer information

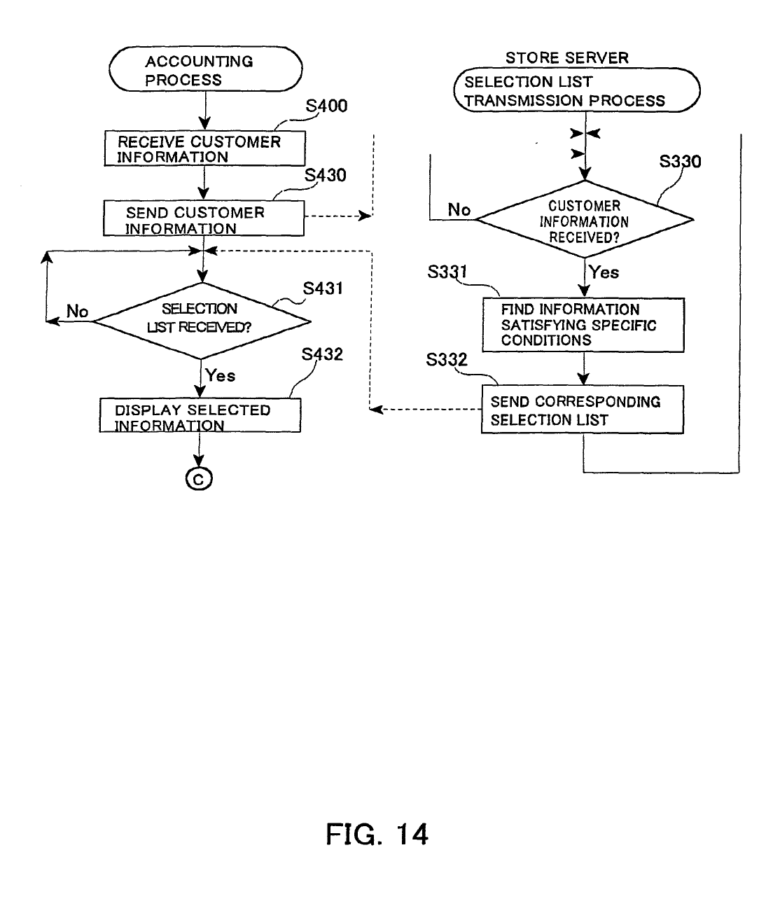

Next, a process for changing the list of information selectable by a customer according to the customer class is described using FIG. 14. FIG. 14 shows process steps replacing steps S400 and S401 of the POS terminal 51, and shows a new process not included in FIG. 13 for the store server 41.

The CPU 60 receives customer information entered by the operator when a customer requests a transaction using the same process shown in FIG. 13 (S400), and sends the customer information through interface 59 to store server 41. When store server 41 receives the customer information through interface 45 (S330 returns yes), it finds advertising placement information (selection list) having the advertising placement conditions satisfied by the customer information (S331).

When the search ends, a list of selectable placement information extracted by the search is sent through interface 45 to POS terminal 51 (S332). POS terminal 51, having received the selection list from store server 41 (S431), displays the selection list on information selection device 54, enabling the customer to select an entry (S432). Processing then continues from branch C from step S402 in FIG. 13.

It is thus possible to provide more appropriate advertising information by displaying as a selection list only advertising information suitable to the advertising target.

It should be noted that the above description explains a system whereby an undetermined number of people can access the application server via the Internet and apply, but a configuration enabling only members to apply is also possible.

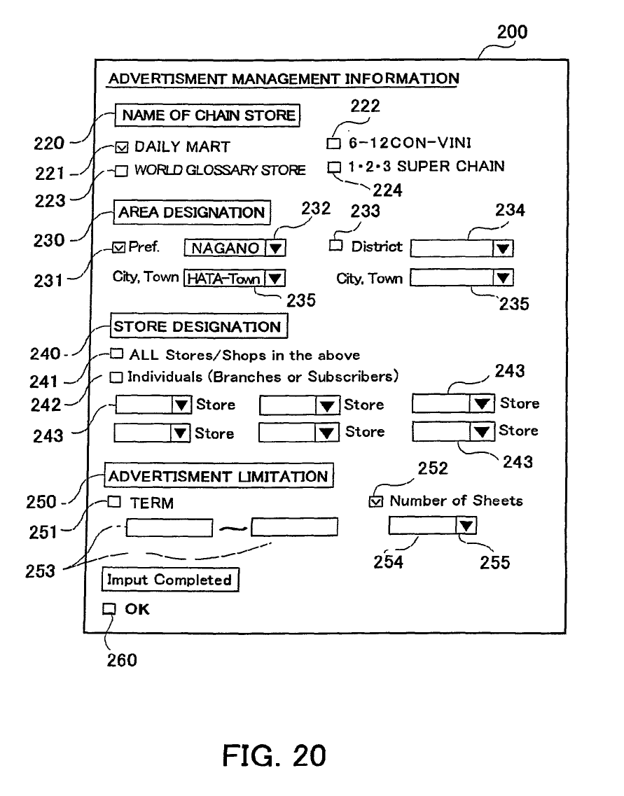

FIG. 20 shows another example of the advertisement management information entry part of the advertisement application page shown in FIG. 10.

In the store name selection item 220, the advertiser first selects, from among the supermarkets, convenience stores, and other stores subscribing to the distribution service, the stores or chains to which the advertisement will be distributed using entry boxes such as check boxes 221, 222, 223, 224. More than one check box can preferably be selected simultaneously.

Whether the advertising area is specified by prefectures, districts or other geographical areas is first selected in advertising area selection item 230 using entry boxes including check boxes 231, 233 and pull-down menus 234, 235. The desired geographical areas can then be selected from pull-down menus 232, 234 wherein the prefecture names and district names are prepared beforehand in the server. If a prefecture is specified, pull-down menus 235, 236 additionally enable specific cities, towns or villages within the selected prefecture to be targeted for distribution. Plural cites, town, and villages can preferably be selected.

Store selection item 240 enables selection of all stores within the selected advertising area or particular individual stores using entry boxes of check boxes 241, 242. If individual checkbox 241 is selected, pull-down menus 243 enable plural individual stores to be selected. The store names are also registered to the server beforehand.

The restrictions selection item 250 enables the advertiser to limit the advertising period (i.e. term) or print count (i.e., number of sheets to be issued) using entry boxes of checkboxes 251, 252. If the advertising period checkbox of “TERM” 251 is selected, the cursor moves to the date entry boxes 253 and further data entry is disabled until the dates are entered (or checkbox 251 is deselected). If the print count checkbox 252 is selected, the cursor moves to the print count entry box 254 to enter the number. Entry of management information is then completed. Note that a pull-down menu 255 can be used instead of or in addition to print count entry box 254 so that units such as 100,000 or 1,000,000 can be more easily entered.

When the complete data entry checkbox 260 is clicked, the management information is sent to the central computer 2, thus enabling the distribution manager to control distribution to the selected stores. If a print count is specified, the number of advertisements printed in each of the stores is tabulated by the central computer 2, and subsequent printing is blocked when the specified print count is reached.

As described hereinabove, according to the present invention, it is possible for an undetermined number of people to freely apply for advertising placement via the Internet 10. By using a system or method according to the present invention, applying for advertising placement can be accomplished very quickly and easily. Furthermore, distributing advertising placement information to various pre-existing store networks can be efficiently accomplished with the present invention, and updating the advertising information is also easy. Moreover, it is possible to specify a particular advertisement distribution area by specifying the area at the level of specific stores. Furthermore, it is possible to provide and place advertisements to meet a wide range of user needs, from advertising for an extremely short period of time to targeted advertising.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A network system having a server system connectable to a client PC via the Internet and to a POS system having a POS terminal device, the POS terminal device having at least a display device and a printing device, said network system comprising:
(a) means for storing an application page containing an advertising placement application form;
(b) means for sending the application page containing the application form to the client PC in response to a request from the client PC;
(c) means for receiving and storing input information containing advertising placement information provided by the client PC in accordance with the application form;
(d) means for distributing specific data in the input information to a POS system specified by the client PC; and
(e) control means for controlling printing the advertising placement information on the POS system receiving the distribution.

2. A network system as described in claim 1, further comprising:
(f) means for calculating an advertising placement fee based on the input information;
(g) means for storing and sending the calculated fee information to the client PC that returned the advertising placement application; and
(h) means for confirming fee payment.

3. A network system as described in claim 1, further comprising:
a plurality of POS systems installed in a plurality of branches or subscriber stores of a chain store.

4. A network system as described in claim 3, wherein the application page enables selection by the client PC of at least one place name from among a plurality of names of places or area where the branches or subscribers exist.

5. A network system as described in claim 3, wherein the application page enables selection by the client PC of one or more chain stores where an advertisement can be placed.

6. A network system as described in claim 3, wherein the application page enables selection by the client PC of at least one branch store name or subscriber store name from among a plurality of branch store names or subscriber store names where an advertisement can be placed.

7. A network system as described in claim 1, wherein the application page enables specification of one or more conditions restricting advertising placement.

8. A network system as described in claim 7, wherein the application page enables specification of an advertising period for advertising placement as one of the conditions.

9. A network system as described in claim 7, wherein the application page enables specification of a number of pages printed for advertising placement as one of the conditions.

10. A network system as described in claim 7, wherein the application page enables specification of a time period in a day for advertising placement which as one of the conditions.

11. A network system as described in claim 1, wherein the application page enables specification of a target for whom the advertising information is presented.

12. A network system as described in claim 1, wherein the POS system has at least one POS terminal with a printer for printing receipts, and advertising information is printed on the front or back side of a receipt.

13. A network system as described in claim 1, wherein the POS system has at least one POS terminal with a customer display device and a printer for printing receipts, and advertising information is printed on a receipt and indicated on the display device.

14. A network system as described in claim 1, wherein means (d) for distribution to said one or more POS systems comprises a central computer that integrally controls the POS systems.

15. A network system as described in claim 1, wherein said POS system or central computer is connected to the server system via the Internet.

16. An advertising information receiving and placement processing method for a network system, the network system having a server system connectable to a client PC via the Internet and to a POS system having a POS terminal device, the POS terminal device having at least a display device and a printing device, said processing method comprising:
(a) sending an application page containing an advertising placement application form in response to a request from the client PC;
(b) receiving and storing input information containing advertising placement information provided by the client PC in accordance with the application form;
(c) calculating an advertising fee based on the input information;
(d) sending to the client PC a payment specification form containing the calculated fee;
(e) confirming fee payment;
(f) registering in the POS system advertising information for which payment has been confirmed; and
(g) outputting advertisement by means of the printing device.

17. An advertising information receiving and placement processing method as described in claim 16, wherein step (e) includes confirming credit card validity.

18. An advertising information receiving and placement processing method as described in claim 16, wherein step (f) comprising sending specific information in the input information to the POS system specified by the input information.

19. An advertising information receiving and placement processing method as described in claim 16, wherein step (f) comprises confirming a corresponding POS system from a desired advertising area specified by the input information, and sending specific information in the input information to the confirmed POS system.

20. An advertising information receiving and placement processing method as described in claim 16, wherein step (f) comprises distributing the advertising information by a central computer connected to a plurality of POS systems.

21. An advertising information receiving and placement processing method as described in claim 16, wherein step (f) comprises sending specific information in the input information to said POS system via the Internet.

22. A computer-readable storage medium having computer-readable program code embodied therein for recording steps in an advertising information receiving and placement processing method as described in claim 16.

23. A network system having a server system connectable to a client PC via the Internet and to a POS terminal device having at least a printing device for printing a receipt or ticket, said network system comprising:
(a) a storage unit for storing an application page containing an advertising placement application form;
(b) an application management unit for sending the application page containing the application form to the client PC in response to a request from the client PC;
(c) a storage unit for receiving and storing input information containing advertising placement information provided by the client PC in accordance with the application form; and
(d) an information distribution managing unit for distributing specific data in the input information to a POS terminal device specified by the client PC;
wherein the POS terminal device to which the specific data is distributed prints the advertising placement information when issuing a receipt or ticket.
